(19) United States
(12) Patent Application Publication
(10) Pub. No.: US 2025/0134621 A1
(43) Pub. Date: May 1, 2025

(54) TOOTH SURFACE LASER PROCESSING METHOD AND LASER PROCESSING SYSTEM FOR THE SAME

(71) Applicant: NATIONAL TSING HUA UNIVERSITY, Hsinchu City (TW)

(72) Inventors: HUNG-WEN CHEN, Hsinchu City (TW); YI-JIUN SHEN, Hsinchu City (TW); CHIA-HUNG CHOU, Hsinchu City (TW); CHIEN-HUNG CHEN, Hsinchu City (TW)

(73) Assignee: NATIONAL TSING HUA UNIVERSITY, Hsinchu City (TW)

(21) Appl. No.: 18/617,171

(22) Filed: Mar. 26, 2024

(30) Foreign Application Priority Data
Oct. 31, 2023 (TW) 112141762

(51) Int. Cl. A61C 1/00; A61C 13/08; A61C 19/06

(52) U.S. Cl. CPC A61C 1/0046; A61C 13/082; A61C 19/06

(57) ABSTRACT

A tooth surface laser processing method and a laser processing system for the same are provided. The laser processing method adapted for a tooth comprises the following steps. The tooth is first checked up to obtain tooth information so that one may determine whether the tooth is suitable for laser processing steps. A laser processing system is chosen according to the tooth information, and laser parameters are selected and loaded according to the part on the surface of the tooth and the degree required to be processed. The laser processing steps are performed on the surface of the tooth by the laser processing system to form a laser processed structure on the surface of the tooth. The laser processed structure comprises a plurality of micro-grooves and a plurality of micro-bumps therebetween.

### TECHNICAL FIELD

The present disclosure relates to a tooth processing method and a tooth processing system thereof, specifically, a tooth surface laser processing method and a laser processing system thereof.

### BACKGROUND

In recent years, as people pursue healthier body and appearance, they try all kinds of methods to show a neat and attractive appearance. Besides exhibiting confidence, a neat and attractive appearance can also draw people's attention. Wherein, beautiful white teeth can mean a healthy body, and white teeth can add charm to a beautiful smile.

In order to have white teeth, besides maintaining dental health, it is necessary to reduce the adhesion of staining liquids such as tea and coffee on the surface of the tooth, which may even permeate into the tooth to cause discolor of the tooth. In addition, the surface of the tooth needs to have an appropriate surface texture structure to produce uniform reflection of incident lights from all directions, so that a teeth whitening effect may be further achieved.

Currently, common whitening methods in dental clinics includes sandblasting whitening, cold light whitening, etc. Sandblasting whitening removes the deposits on the surface of the tooth and restores the original tooth color. It is done by first mixing baking soda and water and then forming a powerful water stream using air pressure. It removes dental plaque, smoke stain, tea stain, coffee stain or betel nut stain on the surface of the tooth. However, if the tooth is not healthy, sandblasting whitening may cause painful feeling in the tooth during the process. Cold light whitening is done by using hydrogen peroxide in high concentration as the whitening agent and irradiating the tooth with blue light, so that the agent can perform an oxidation-reduction reaction on the surface of the tooth and achieve a whitening effect. However, due to the high concentration of the agent, it is easy to cause sensitivity and discomfort to the users.

Therefore, it is an urgent problem to be solved for people skilled in the art to help the users achieve a whitening effect together with an anti-stain and antibacterial effect and reduce the feeling of pain or discomfort during the whitening process.

### SUMMARY

An object of the present invention is to provide a tooth surface laser processing method and a laser processing system thereof. Using the laser processing system to perform laser processing steps can form a laser processed structure on the surface of the tooth. During the process, the user won't feel the laser processing process, therefore there is no discomfort to the user. The laser processed structure formed by the laser processing steps can uniformly reflect, refract, diffract, and scatter the incident light, so other people can see the tooth appearing uniformly white, thereby achieving a whitening effect. In addition, the micro grooves and the micro bumps formed by the laser processing steps can increase the hydrophobicity of the surface of the tooth and relatively enhance the anti-stain effect. Furthermore, the micro grooves and the micro bumps make it difficult for bacteria to adhere onto the surface of the tooth, so the chance of biofilm formation is reduced and the antibacterial effect is improved.

An embodiment of the invention provides a tooth surface laser processing method for a tooth which includes the following steps. First, perform a preliminary inspection on the tooth for treatment to obtain dental information, and determine whether the tooth is suitable for laser processing steps. Select a laser processing system according to the dental information, and select and load the laser parameters according to the position and degrees of processing required on a surface of the tooth selected. By Use the laser processing system and perform the laser processing steps on the surface of the tooth, thereby forming a laser processed structure on the surface of the tooth, wherein the laser processed structure includes a plurality of micro grooves and a plurality of micro bumps between the micro grooves.

An embodiment of the invention provides a laser processing system which includes a laser source, a scanning unit and a control unit. The laser source irradiates a laser beam. The scanning unit receives the laser beam and irradiates the laser beam on a surface of a tooth, thereby forming a laser processed structure on the surface of the tooth, wherein the laser processed structure includes a plurality of micro grooves and a plurality of micro bumps between the micro grooves. The control unit electrically connects to the laser source and the scanning unit, so as to control the laser source and the scanning unit.

Compared to prior art, the tooth surface laser processing method and the laser processing system use laser processing steps to process the surface of the tooth, thereby forming a laser processed structure with a plurality of micro grooves and micro bumps. By adjusting the groove spacing and groove depth, the reflection and scattering angle of the incident light on the surface of the tooth can be changed, so that the tooth can present a uniform natural color, and change the roughness and moisturization level of the surface of the tooth at the same time. Through the micro grooves and the micro bumps, micro-nano textured structures can also be formed to give the surface of the tooth a super-hydrophobic structure, so that staining liquids cannot easily adhere to the surface of the tooth and form deposits. In addition, an antibacterial textured structure can also be formed to make dental plaque difficult to adhere to the surface of the tooth and form biofilm.

### BRIEF DESCRIPTION OF THE DRAWINGS

FIG. 1 is a tooth surface laser processing method according to an embodiment of the invention.

FIG. 2A is a schematic front view of a surface of a tooth according to an embodiment of the invention.

FIG. 2B is a top view of a surface of a tooth according to an embodiment of the invention.

FIG. 2C is a schematic 3-D structural view of a structure of a surface of a tooth according to an embodiment of the invention.

FIG. 3 is a schematic structural view of a laser processing system according to an embodiment of the invention.

FIG. 4 is a schematic enlarged view of a laser processed structure processed by tooth surface laser processing according to an embodiment of the invention.

FIG. 5A is a schematic front view of a laser processed structure according to an embodiment of the invention.

FIG. 5B is a schematic cross-sectional view of a laser processed structure along a cross-sectional line A-A′ of FIG. 5A according to an embodiment of the invention.

FIG. 5C is a schematic 3-D structural view of a laser processed structure according to an embodiment of the invention.

FIG. 6 is a schematic structural view of an artificial denture according to an embodiment of the invention.

FIG. 7A is a schematic view of the state of a laser processing system when processing a user's teeth according to an embodiment of the present invention.

FIG. 7B is a schematic structural view of a laser processing system with the assistance of a U-shaped rail according to an embodiment of the present invention.

FIG. 8 is a schematic cross-sectional view of a laser processing system used to process the outer side surface of a tooth according to an embodiment of the present invention.

FIG. 9 is a schematic cross-sectional view of a laser processing system used to process the top side surface of a tooth according to an embodiment of the present invention.

FIG. 10 is a schematic cross-sectional view of a laser processing system used to process the inner side surface of a tooth according to an embodiment of the present invention.

FIG. 11 is a schematic cross-sectional view of a laser processed structure according to another embodiment of the invention.

### DETAILED DESCRIPTION

In each of the embodiment of the invention, the terminology used herein is only used to describe the particular embodiments and is not for limitation. As described herein, unless the specification clearly indicates otherwise, singular forms such as “a”, “an” and “the” are intended to include plural forms and “at least one.” As described herein, the terminology “a” includes any or all combinations of one or more associated items.

In the embodiments of the invention, the terms “up”, “down”, “left”, “right”, “front” and “back” in the specification are only used to describe the relationship between one element and another element, and these terms are only used to describe the orientation in the figures and are not used to limit the actual positions. The directions and the orientations of the devices in the figures are not limited by the reversion of the devices. The directions of D1 axis, D2 axis and D3 axis in the figures intersect perpendicularly and respectively, just as the X axis, Y axis and Z axis of the Cartesian coordinate system; however, their corresponding relationships are not limited thereto.

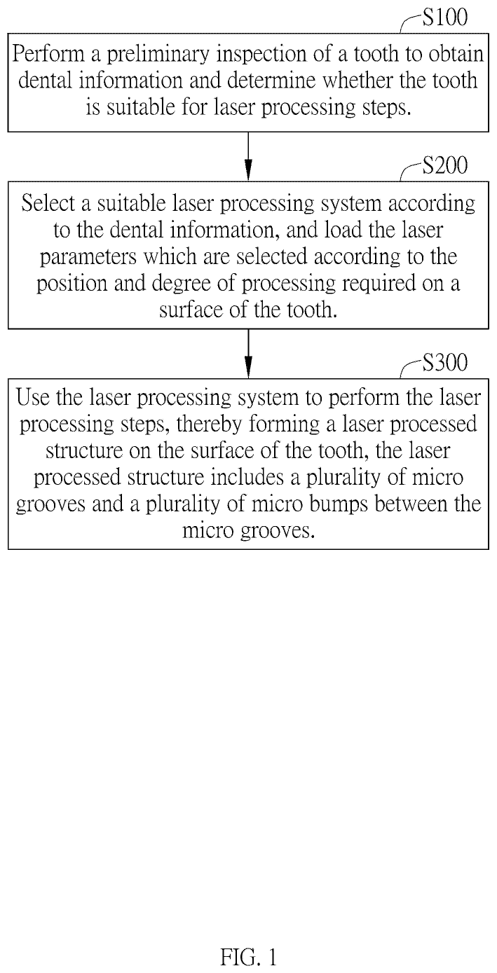

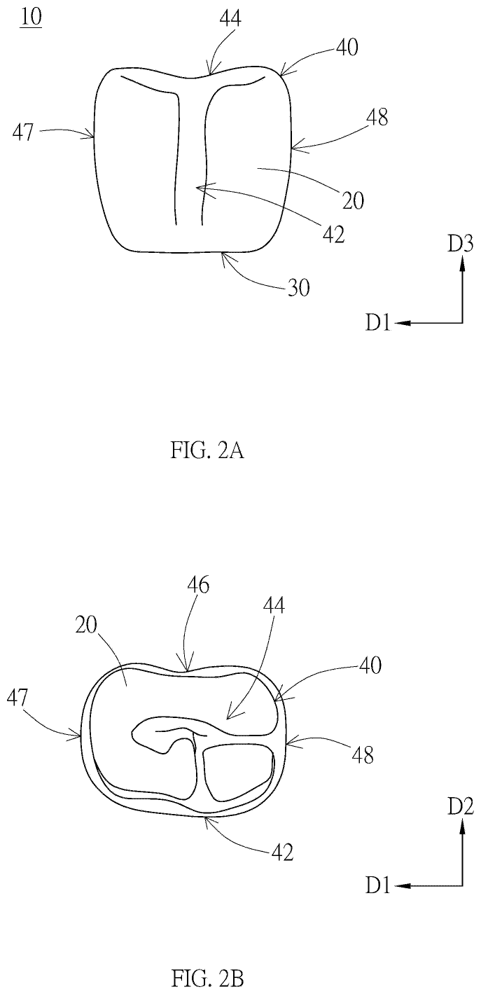

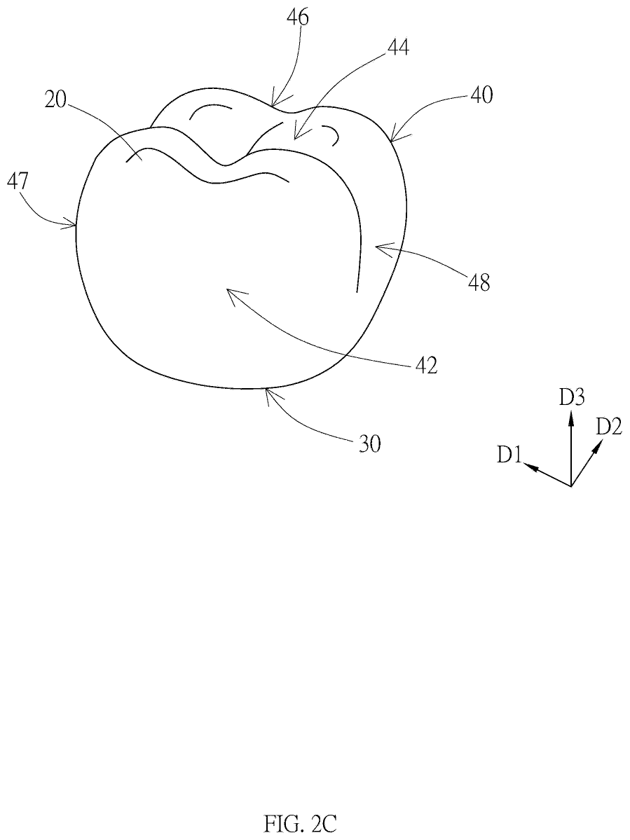

FIG. 1 is a tooth surface laser processing method according to an embodiment of the invention. FIG. 2A, FIG. 2B and FIG. 3C are a schematic front view, a top view and a 3-D structural view of a surface of a tooth according to an embodiment of the invention. FIG. 3 is a schematic structural view of a laser processing system according to an embodiment of the invention. Please refer to FIG. 1 to FIG. 3. In order to show the technologies and advantages of the invention, the size, proportion and structural representations in the drawings will be appropriately adjusted to make it easier to understand the purposes and advantages of the invention. The laser processing system 1000 of the invention is only used for illustration and does not represent the actual size and configuration. Without departing from the spirit and scope of the invention, the people skilled in the art can appropriately modify the structural design of the laser processing system 1000 to achieve the effects of the invention.

Please refer to FIG. 1, FIG. 2A to FIG. 2C. First, perform a preliminary inspection of tooth 10 to obtain dental information and determine whether the tooth 10 is suitable for laser processing steps LPS (Step S100). The inspection of the tooth 10 includes checking the health status of the tooth and determining whether the tooth is suitable for the laser processing steps LPS, for example, checking whether there are dental pulp cavity diseases, periodontal disease, dental caries, etc. If so, treatments should be performed first to restore the tooth to sufficient health before performing the laser processing steps LPS. In addition, the inspection of the tooth 10 also includes checking the physical status of the tooth 10, for example, checking whether there are dentures, the material and the installed position of the dentures, and whether the pigmentation on the surface of the tooth is serious, if so, the tooth should be cleaned to remove the surface pigment.

If the tooth is healthy for performing the laser processing steps LPS, a tooth cleaning step can be performed to clean the tooth and remove dirt and residue from the surface of the tooth 10. It can prevent the dirt and residue from absorbing the irradiated laser energy and affecting the effect of the laser processing steps LPS.

Please refer to FIG. 1, and FIG. 2A to FIG. 2C. Next, select a suitable laser processing system 1000 according to the dental information I, and load the laser parameters LP which are selected according to the position and degree of processing required on the surface of the tooth (step S200). For example, different laser systems can be selected according to different materials of the dentures and dermal tooth, and the corresponding required laser parameters LP, e.g., laser type, laser wavelength, laser power, pulse width, laser spot diameter, etc., can be loaded.

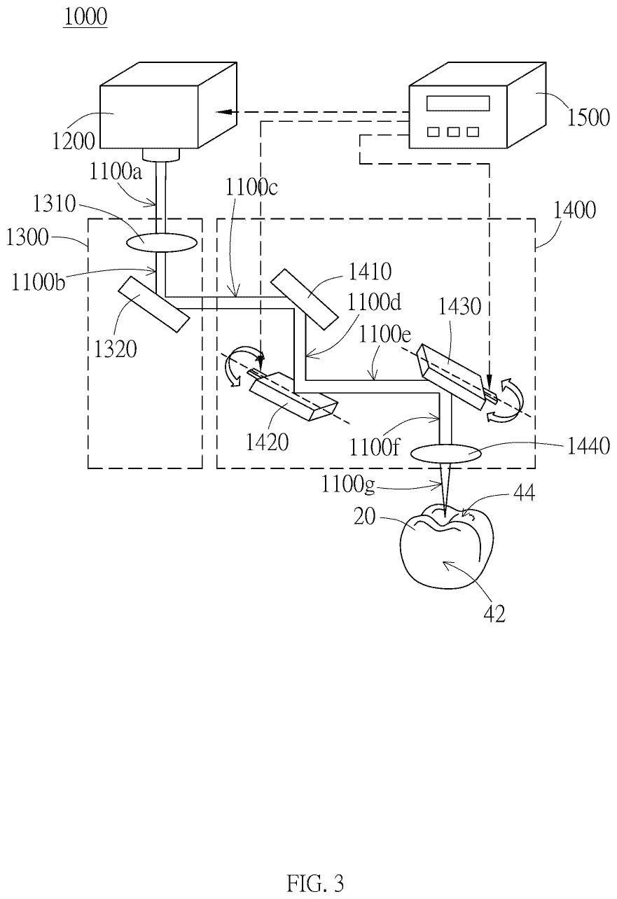

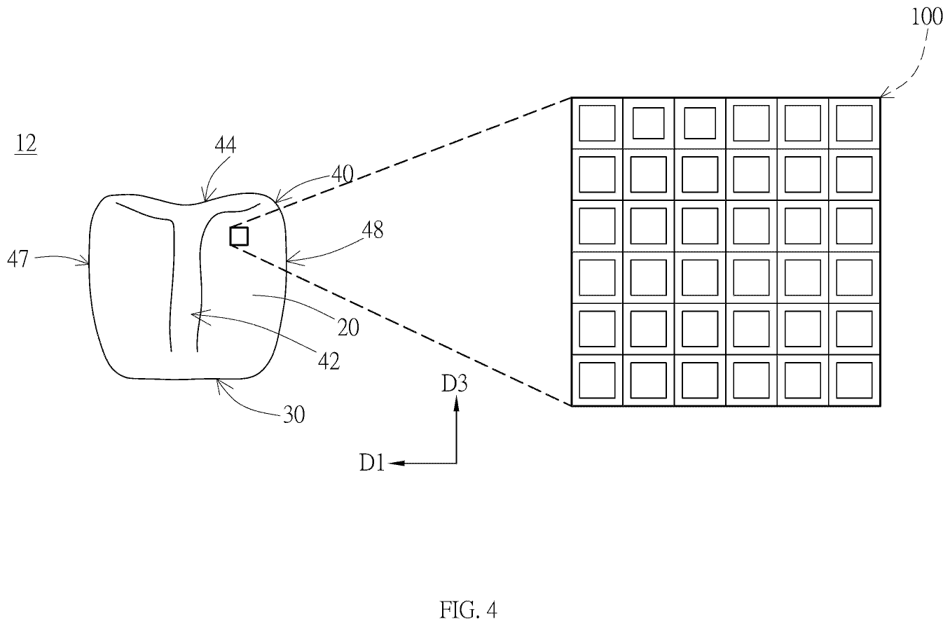

Please refer to FIG. 1, and FIG. 2A to FIG. 2C. Use the laser processing system 1000 to perform the laser processing steps LPS, thereby forming a laser processed structure 100 (as shown in FIG. 4 and FIG. 5A to FIG. 5C) on the surface of the tooth 10. The laser processed structure 100 includes a plurality of micro grooves 110 and a plurality of micro bumps 120 between the micro grooves 110 (step S300).

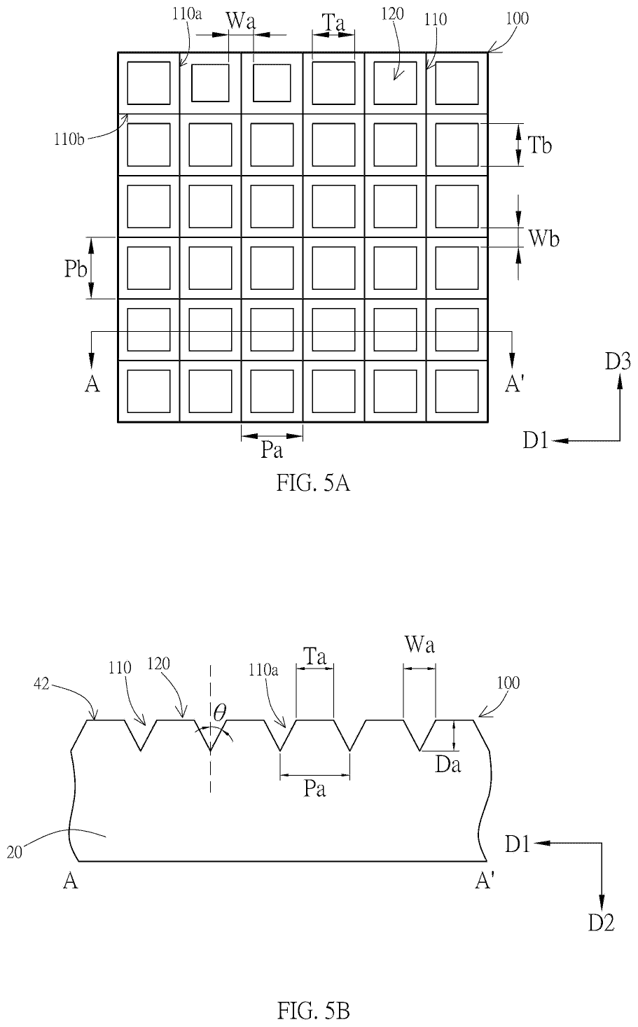

Please refer to FIG. 2A to FIG. 2C. In the embodiment, a molar tooth is used as an example; however, the invention may be applied to other teeth and is not limited thereto. The tooth 10 includes at least a dental crown 20, a bottom 30 and a surface 40. Among them, the dental crown 20 can be the crown of a denture or the crown of a dermal tooth. The bottom 30 can be connected to a implanting base 50 and an implanted body 60 (as shown in FIG. 6), or can be connected to the root of a dermal tooth (not shown), but is not limited thereto. The surface 40 of the tooth 10 includes an outer side surface 42, a top side surface 44, an inner side surface 46, a first side surface 47 and a second side surface 48. The outer side surface 42 faces the outside and shows the surface of tooth 10 that is normally seen from the outside. The inner side surface 46 faces the inside. The top side surface 44 is the side of the upper row and the lower row teeth used in chewing food. Since the outer side surface 42 is usually seen by human eyes, the whitening result of it directly affects people's impression of the teeth whitening effect.

Please refer to FIG. 3. In the embodiment, the laser processing system 1000 is used as an example, but the invention is not limited thereto. The laser processing system 1000 includes at least a laser source 1200, a scanning unit 1400 and a control unit 1500. The laser source 1200 can be, for example, a pulsed laser or a continuous-wave laser. The pulsed laser source 1200 can, for example, use lasers with different laser pulse width such as nano-second laser, pico-second laser or femto-second laser. These lasers can have better laser peak powers. Among them, the pico-second laser and the femto-second laser can concentrate energy to accurately draw lines on the surface 40 of the tooth, making it suitable for manufacturing shallow grooves. The laser source 1200 can use different laser source materials such as solid laser, semiconductor laser, gas laser or liquid laser. The solid laser source can be yttrium aluminum garnet (YAG) laser, neodymium-doped yttrium aluminum garnet (Nd: YAG) laser or diode-pumped solid-state (DPSS) laser, but it is not limited thereto. The semiconductor laser can be aluminum gallium arsenide (AlGaAs) laser or indium gallium arsenide phosphide laser, but it is not limited thereto. The gas laser can be carbon dioxide (CO₂) laser, but it is not limited thereto. If necessary, fiber laser can also be used. The fiber (not shown) can be used as a gain medium to improve photoelectric conversion efficiency and adjust laser power and output quality.

Please refer to FIG. 3. The laser beam 1100a irradiated from the laser source 1200 can be transmitted to the scanning unit 1400 through a transmitting unit 1300. A lens 1310 and a reflector 1320 can be disposed inside the transmitting unit 1300. The diameter of the laser beam 1100a can, for example, be modified through the lens 1310 to form a laser beam 1100b. Then, the laser beam 1100b can, for example, be reflected by the reflector 1320 to form a laser beam 1100c onto the scanning unit 1400, but it is not limited thereto. The laser beam 1100a can, for example, also be directly transmitted to the scanning unit 1400 through a fiber (not shown) to improve the flexibility of design and use.

Please refer to FIG. 3. The scanning unit 1400 includes at least a first galvanometer1420, a second galvanometer1430 and a f-θ lens 1440. In addition, the scanning unit 1400 can include a reflector 1410. The laser beam 1100c transmitted by the transmitting unit 1300 can be reflected by the reflector 1410 to form a laser beam 1100d onto the first galvanometer1420. The laser beam 1100d can be reflected onto a position on the second galvanometer1430 by adjusting the first galvanometer1420. A laser beam 1100e reflected by the first galvanometer1420 is reflected onto a position on the f-θ lens 1440 by adjusting the second galvanometer1430. A laser beam 1100f reflected by the second galvanometer1430 can be focused and finely adjusted by the f-θ lens 1440 to form a laser beam 1100g. The laser beam 1100g can be accurately focused on the outer side surface 42, top side surface 44 or the inner side surface 46 of the tooth crown 20. Using the first galvanometer 1420 and the second galvanometer1430 to control the irradiation position of the laser beam 1100g, one can perform horizontal scanning along the XY direction. The first galvanometer 1420 and the second galvanometer 1430 are preferably digital galvanometers, whose deflection angle can be accurately controlled to achieve high-speed and accurate scanning. The digital galvanometer can be collocated with f-θ lens to accurately control the irradiation position (e.g., the top side surface 44) of the laser beam 1100g, and the accuracy of the scanning irradiation position can reach 1 μm. The control unit is electrically connected to the scanning unit 1400 to control the actions of the laser source 1200 and the scanning unit 1400.

FIG. 4 is a schematic enlarged view of a laser processed structure of a tooth surface laser processing according to an embodiment of the invention. After performing the laser processing steps LPS on the tooth 10, a laser processed structure 100 is formed on the surface 40 of the tooth, thereby a tooth 12 with the laser processed structure 100 is formed.

FIG. 5A is a schematic front view of a laser processed structure according to an embodiment of the invention. FIG. 5B is a schematic cross-sectional view of a laser processed structure along a cross-sectional line A-A′ of FIG. 5A according to an embodiment of the invention. FIG. 5C is a schematic 3-D structural view of a laser processed structure according to an embodiment of the invention. Please refer to FIG. 5A to FIG. 5C. In the laser processing steps LPS, the laser beam 1100g of the laser processing system 1000 can form the laser processed structure 110 on the surface 40 of the tooth 10, which includes a plurality of micro grooves 110 and a plurality of bumps 120 between the micro grooves 110. The micro grooves 110 can be continuous long strip grooves, or discontinuous short grooves or holes. The micro bumps 120 can be continuous long strip bumps or discontinuous short bumps or dot bumps, but not limited thereto. The micro grooves 110 can include, for example, a first micro groove 110a along a direction D3 and a second micro groove 110b along a direction D1, wherein the first micro groove 110a interlaces with the second micro groove 110b. The laser beam 1100g of the laser processing system 1000 can be used to draw parallel lines on the surface 40 of the tooth 10 along the directions D3 and D1 to form the micro grooves 110a and 110b. The pitch Pa between the micro grooves 110a and the pitch Pb between the micro grooves 110b can be adjusted by the line spacing of the laser beam 1100g. For example, the pitch Pa between the micro grooves 110a can be between 0.5 μm and 500 μm, and the pitch Pb between the micro grooves 110b can be between 0.5 μm and 500 μm, but not limited thereto. The pitch Pa can be the same or not the same as the pitch Pb. The spacing between the micro bumps 120 can be adjusted by the pitch Pa and Pb. For example, the groove width Wa of the micro groove 110a and the groove width Wb of the micro groove 110b can be between 0.5 μm and 500 μm, and preferably between 10 μm and 300 μm, but are not limited thereto. In a variant embodiment, the micro groove 110a and the micro groove 110b can be manufactured by drawing lines along an inclined direction between the axis D1 and the axis D3 to form rhombus-shaped micro bumps. In another variant embodiment, another set of the parallel plurality of the micro grooves can also be added to form triangular micro bumps interlaced with the micro groove 110a and the micro groove 110b. The micro groove 110a and the micro groove 110b are not limited to straight lines; they can also be curved lines. The micro groove 110a and the micro groove 110b are interlaced to form interlaced tetragonal or hexagonal micro bumps. In addition, the micro groove 110a and the micro groove 110b can also be curved lines with several periodic bends to form several periodic arrangements of micro bumps. Or, the micro groove 110a and the micro groove 110b can be curved lines with random periodic bends to form the micro bumps with random arrangements, but are not limited thereto.

Please refer to FIG. 5A to FIG. 5C. The micro groove 110a and the micro groove 110b respectively have the groove width Wa and the groove width Wb. The size of the micro bump 120 can be adjusted by adjusting the pitch Pa, the pitch Pb, the groove width Wa and the groove width Wb. The top widths Ta and Tb of the micro bump 120 can be between 1 μm and 400 μm, and preferably between 10 μm and 300 μm, but they are not limited thereto. The size of the top surface of the micro bump 120 can be between 1 μm×1 μm and 400 μm×400 μm, but it is not limited thereto. The diameter of the laser speckle of the laser beam 1100g and the beam profile of the laser beam 1100g can be adjusted by adjusting the energy distribution of the laser beam 1100g. Thus, the required groove widths Wa and Wb, and the groove depths Da and Db (the groove depth Db is not shown) can be formed when the laser beam 1100g draws lines. The groove depths Da and Db can be between 0.5 μm and 500 μm, but not limited thereto. The micro groove 110a and the micro groove 110b are not limited to V-shaped grooves. The micro groove 110a and the micro groove 110b can also be formed into a U shape by adjusting the laser beam 1100g to a flat top beam. The side wall inclined angle θ of the micro groove 110a and the micro groove 110b can be adjusted. The angle θ is between 1° and 80°, preferably between 10° and 60°, but it is not limited thereto. The ambient incident light can be uniformly reflected, refracted, diffracted or scattered to the front, so as to make the tooth 10 look more white or spotless. The laser processed structure 100 on the outer side surface 42 of the tooth 10 can be designed to cause local interference to the reflected light, so that the whitening effect can be further improved. For example, the minimum just noticeable difference (JND) of the reflected light before and after the laser processed structure 100 is completed can be measured to determine the whitening effect, but it is not limited thereto. The invention can make the reflected light more uniform and achieve a whitening effect by adjusting the size of the top surface of the micro bumps 120 and the side wall inclined angle θ (an angle between the side wall and the normal) of the micro grooves 110a and 110b. Moreover, it will not cause pain or discomfort during the laser processing steps LPS. In addition, the hydrophobicity of the surface of the tooth can be increased by the design of the micro grooves 110a, 110b and the micro bumps, thereby increasing the anti-stain capability of the tooth. At the same time, the antibacterial capability of the tooth can be increased by reducing the chances of bacteria attaching to the surface of the tooth via pili, flagella or sticky substances, so that dental caries or periodontal disease can be prevented. In an embodiment, the laser processed structure 100 can be formed by the technique of laser induced periodic surface structure (LIPSS), but it is not limited thereto.

FIG. 6 is a schematic structural view of an artificial denture according to an embodiment of the invention. Please refer to FIG. 2A, FIG. 4 and FIG. 6. The laser processed structure 100 of the invention can be formed on the tooth crown surface 40A of the artificial denture. The tooth 10 can be an artificial denture, such as an artificial denture used in a dental implantation. The tooth 10 can include, for example, an artificial tooth crown 20A, a base 50 and an implanted body 60, but not limited thereto. The tooth 10 can also be a dermal tooth but is not limited thereto. The surface 40 of the tooth 10 includes the tooth crown surface 40A. The material of the artificial tooth crown 20A can be metal, ceramic, porcelain-fused-to-metal or other materials. For example, the metal material can be titanium alloy, palladium silver alloy, palladium gold alloy, palladium platinum alloy, etc., but not limited thereto. The ceramic material can be zirconium oxide, lithium oxide, etc., but not limited thereto. The porcelain-fused-to-metal can be a ceramic outer layer sintered on a metal inner layer. The metal and the ceramic can be the materials described above, but not limited thereto. The other materials can be resin material, dentin material, enamel material, etc., but not limited thereto. The laser processed structure 100 can also be formed on the surface (not shown) of the artificial denture veneer, or it can be formed on the surface of a dermal tooth. If zirconium oxide is used on the surface of the tooth, Yd: YAG laser or carbon dioxide laser can be used, and the laser energy density and the laser impulse width should be appropriately adjusted. The diameter of the laser speckle should be adjusted to achieve the best surface texture affect. If the surface of the tooth is enamel, the laser with lower laser energy density and wider diameter of the laser speckle can be used to avoid thermal deformation or cracking of the material. Longer laser impulse width and lower laser impulse frequency can be used to achieve better texture effect due to the higher hardness of enamel. If the surface of the tooth is dentin, the laser with higher laser energy density and narrower diameter of the laser speckle can be used to achieve better cutting effect. Shorter laser impulse width and higher laser impulse frequency can be used to achieve better texture effect due to the higher hardness of dentin. If the tooth 10 is artificial denture (such as artificial denture for dental implant, or denture patch), the laser processing steps LPS can be performed on the artificial denture in advanced, or the laser processing steps LPS can be performed after the artificial denture is implanted; there is no restriction to the sequence.

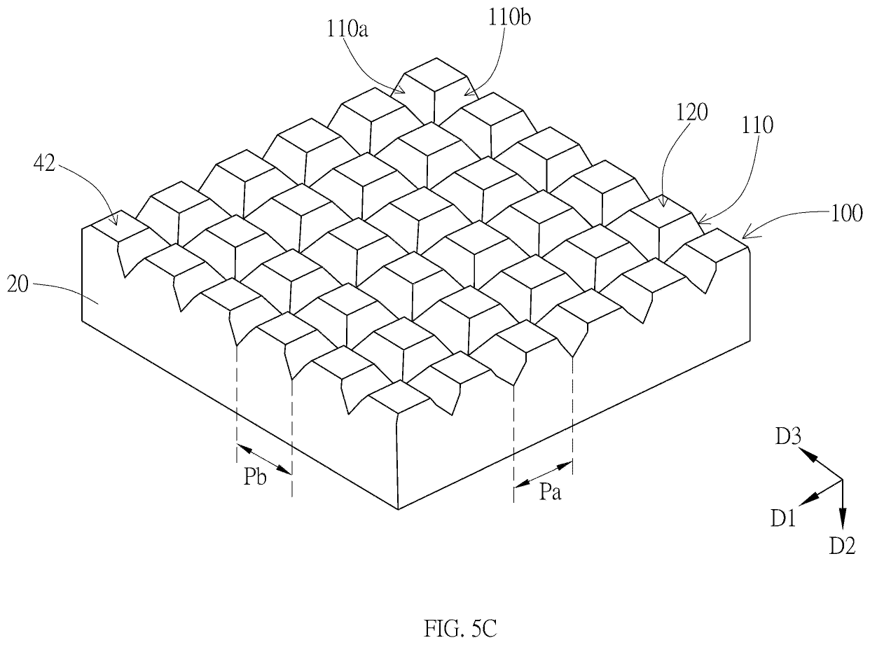

FIG. 7A is a schematic view of the state of a laser processing system when processing a user's teeth according to an embodiment of the present invention. FIG. 7B is a schematic structural view of a laser processing system with the assistance of a U-shaped rail according to an embodiment of the present invention. Please refer to FIG. 3 and FIG. 7A. The scanning unit 1400 can be installed into a laser head 1600, so that the operator can easily operate the laser processing system 1000. A fiber lens (not shown) can be installed into the laser head 1600 and connected to an operating screen, and the operator can conveniently move and operate the laser head 1600 to align and position the tooth to be processed, so that the laser processing steps LPS can be accurately performed. The user can wear a mouth opener 1700 and a goggle in advanced, so as to prevent accidental injuries cause by the laser beam in the laser head 1600. Please refer to FIG. 3 and FIG. 7B. Besides the hand-held laser head 1600, the scanning unit 1400 can also be installed on a U-shaped rail 1800 to assist the scanning unit 1400 in aligning the tooth 10 to be processed. The U-shaped rail 1800 can be used to auto-aligned the tooth to be processed, and the movement accuracy can reach 1 μm. The U-shaped rail 1800 can move to a fixed position via a connecting bracket 1900 to facilitate the operator to use the scanning unit 1400 to perform the laser processing steps LPS on the surface of the tooth. If fiber is used as the transmitting unit 1300, the fiber can be buried into the connecting bracket 1900 to improve on convenience and appearance.

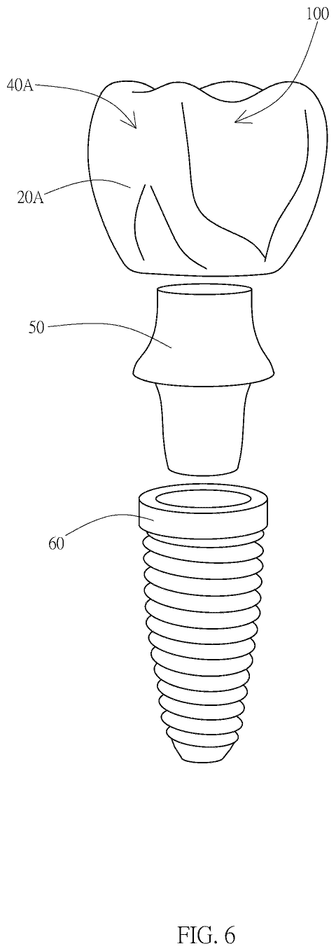

FIG. 8 is a schematic cross-sectional view of a laser processing system used to process the outer side surface of a tooth according to an embodiment of the present invention. Please refer to FIG. 5A to FIG. 5C and FIG. 8. In the embodiment, the laser beam 1100g of the laser processing system 1000 can be directly irradiated on the user's tooth. The laser processed structure 100 can be formed on the outer side surface 42U of an upper tooth and the outer side surface 42L of a lower tooth, so as to further whiten the tooth 12 of the user. In addition, laser processing using a light guiding unit can be performed on the inner side surface 46U of the upper tooth and the inner side surface 46L of the lower tooth as described later.

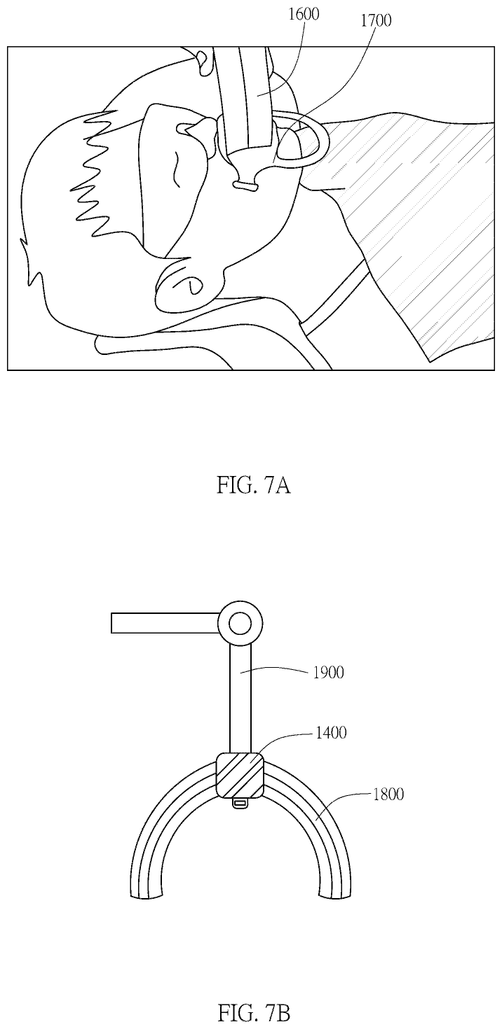

FIG. 9 is a schematic cross-sectional view of a laser processing system used to process the top side surface of a tooth according to an embodiment of the present invention. Please refer to FIG. 5A to FIG. 5C and FIG. 9. In the embodiment, the light guiding unit 2000 can be used to perform the laser processing steps LPS on the top side surface 44. The light guiding unit 2000 can include a light guiding portion 2200, a reflecting portion 2300 and a supporting portion 2400. The reflecting portion 2300 is connected to the light guiding portion 2200, and the supporting portion 2400 is connected to the reflecting portion 2300. In addition, a separating portion 2100 can be disposed in the middle of the light guiding unit 2000 to prevent the laser beam 1100g from irradiating the non-target area. A tooth container 2500 is formed by the light guiding portion 2200, the reflecting portion 2300 and the supporting portion 2400 to hold the upper row and the lower row of the user's teeth, and the user can conveniently bite into it and fix the tooth to be processed. The light guiding unit 2000 can be integrated with the mouth opener 1700 to improve the convenience of use. The material of the light guiding unit 2000 can be silicone, epoxy resin, or acrylic to improve the comfort of use, but it is not limited thereto. A reflecting material such as metal can be added into the reflecting portion 2300 to improve the reflectivity. The laser beam 1100g of the laser processing system 1000 can irradiate the light guiding portion 2200 and be reflected by the reflecting portion 2300 to the top side surface 44U of the upper tooth and the top side surface 44L of the lower tooth, so as to form the required laser processed structures 100 on the top side surfaces 44U and 44L.

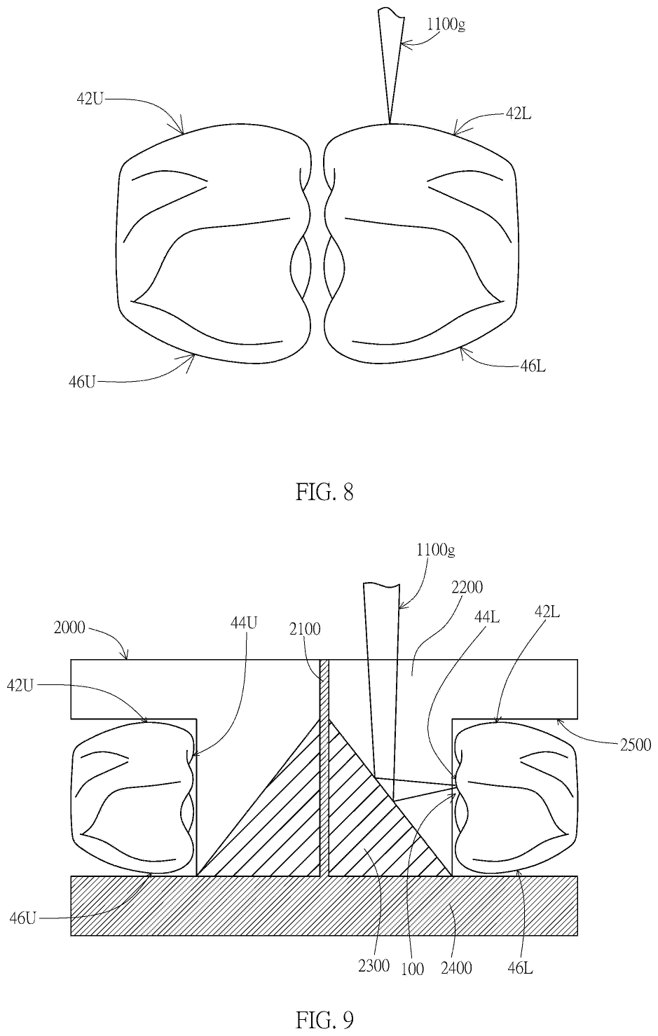

FIG. 10 is a schematic cross-sectional view of a laser processing system used to process the inner side surface of a tooth according to an embodiment of the present invention. Please refer to FIG. 5A to FIG. 5C and FIG. 10. In the embodiment, the light guiding unit 3000 is used to perform the laser processing steps LPS on the inner side surface 46. The light guiding unit 3000 can include a light guiding portion 3200, a reflecting portion 3300 and a supporting portion 3400. The reflecting portion 3300 is connected to the light guiding portion 3200, and the supporting portion 3400 is connected to the reflecting portion 3300. In addition, a separating portion 3100 can be disposed in the middle of the light guiding unit 3000 to prevent the laser beam 1100g from irradiating the non-target area. The material of the light guiding unit 3000 can be silicone, epoxy resin, or acrylic to improve the comfort of use, but it is not limited thereto. A tooth container 3500 is formed by the light guiding portion 3200, the reflecting portion 3300 and the supporting portion 3400 to hold the upper row and the lower row of the user's teeth, the user can conveniently bite into it and fix the tooth to be processed. The light guiding unit 3000 can be integrated with a mouth opener 1700 to improve the convenience of use. The laser beam 1100g of the laser processing system 1000 can irradiate the light guiding portion 3200 and be reflected twice by the reflecting portion 3300 to the inner side surface 46U of the upper tooth and the inner side surface 46L of the lower tooth, so as to form the required laser processed structures 100 on the top side surfaces 46U and 46L.

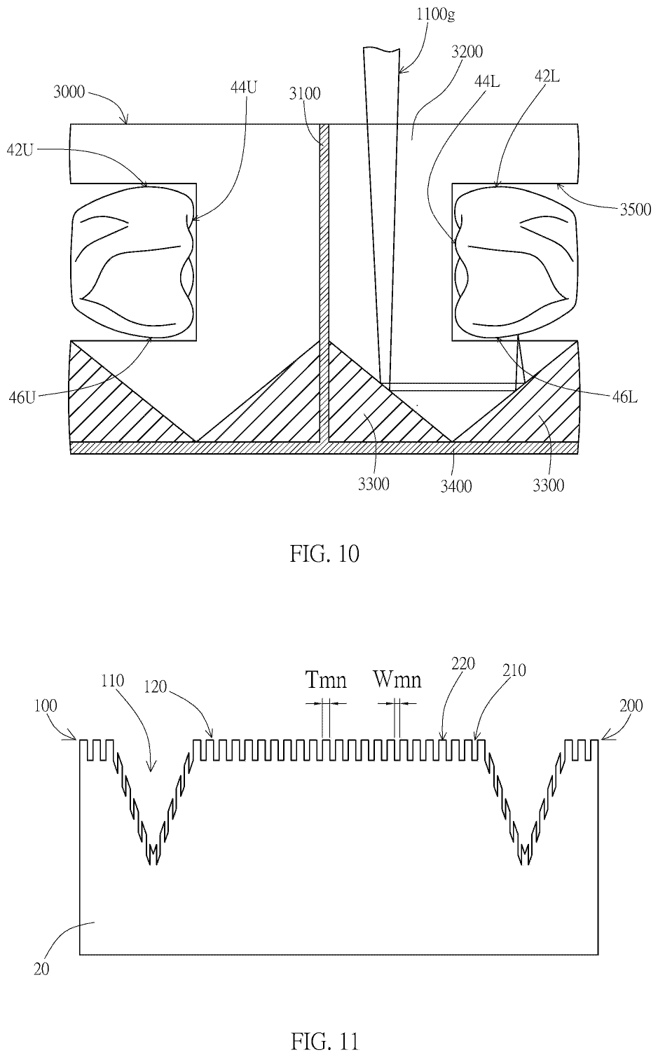

FIG. 11 is a schematic cross-sectional view of a laser processed structure according to another embodiment of the invention. Please refer to FIG. 5A to FIG. 5C and FIG. 10. In the embodiment, besides the first sub-step of forming the micro groove 110 and the micro bump 120 of the laser processed structure 100, a second sub-step of forming a micro-nano processed structure 200 on the surfaces of the micro groove 110 and the micro bump 120 of the laser processed structure 100 can be further included. The micro-nano processed structure 200 includes a plurality of micro-nano grooves 210 and micro-nano bumps 220 formed between the micro-nano grooves 210. For example, the micro-nano grooves 210 have a groove width Wmn between 0.5 μm and 10 μm, but it is not limited thereto. The micro-nano bumps 220 have a top width Tmn between 0.5 μm and 10 μm, but it is not limited thereto. In the embodiment, the second sub-step can use another laser processing system or the same laser processing system 1000. Smaller micro-nano grooves 210 and micro-nano bumps 220 can be formed by using a different laser source or adjusting the laser energy density and the diameter of the laser speckle. For example, the diameter of the laser speckle can be between 0.5 μm and 10 μm, but it is not limited thereto. In a variant embodiment, the energy distribution of the laser speckle can be adjusted by adjusting the transverse wave fundamental mode (TEM) of the laser speckle. The required micro-nano processed structure 200 can be formed by forming a plurality of wave peaks in the laser speckle.

Refer to FIG. 5A, FIG. 5B and FIG. 11. The groove width Wmn of a micro-nano groove 210 is smaller than the groove widths Wa and Wb of a micro groove 110, and the top width Tmn of a micro-nano bump 220 is smaller than the top widths Ta and Tb of a micro bump 120. Since the micro-nano grooves 210 and the micro-nano bumps 220 have smaller widths, they can assist in increasing the light scattering effect, thereby further improving the whitening effect. In addition, the micro-nano grooves 210 and the micro-nano bumps 220 have superhydrophobicity, so the surface contact angle of a liquid drop can exceed 120°, thereby reducing the adhesion of liquids containing dyeing substances and further increasing its anti-stain effect. Furthermore, because the micro-nano grooves 210 and the micro-nano bumps 220 have smaller widths, it is difficult for bacteria to adhere to the surface of the tooth, and the antibacterial effect can be further increased. In a variant embodiment, for example, the structural parameters of the micro grooves 110 and the micro bumps 120 of the laser processed structure 100 can be adjusted to suitable numbers to enhance the whitening effect, and the structural parameters of the micro-nano grooves 210 and the micro-nano bumps 220 of the micro-nano processed structure 200 can also be adjusted to enhance anti-stain and antibacterial effects. Thus, both the whitening and antibacterial effects can be enhanced by using different structural parameters of the laser processed structure 100 and the micro-nano processed structure 200. With respect to the pattern or other parts of the micro-nano processed structure 200, one can refer to the related descriptions of the laser processed structure 100 described above, and it will not be described herein.

In another embodiment, the laser processing system and the laser parameters can also be suitably selected in the second sub-step to form laser induced periodic surface structures (LIPSS) on the surface of the micro grooves 110 and the micro bumps 120 of the laser processed structure 100, thereby forming the required micro-nano processed structures 200through the LIPSS.

In another embodiment of the invention, in the laser processing steps described above for forming the LIPSS, one can also appropriately adjust the laser parameters to adjust the energy distribution of the laser speckle. A plurality of the wave peaks can be formed in the laser speckle, making the energy in the center of the laser speckle highest and gradually decreasing outward. Thus, the micro groove 110, the micro-nano groove 210 and the micro-nano bump 220 of the micro groove 110 can be formed in one laser irradiation process, as shown in FIG. 11. In addition, by greatly reducing the top widths Ta and Tb of the micro bumps 120 between the micro grooves 110, the groove widths Wa and Wb will approach the pitches Pa and Pb. In this way, a combined step in which the first sub-step and the second sub-step simultaneously take place can be achieved in one laser irradiation process. In other words, in the laser processing steps LPS, the first sub-step and the second sub-step can be simultaneously performed in a combined step, thereby simultaneously forming the laser processed structure 100 and the micro-nano processed structure 200, so as to simplify the operating process and shorten the operating time. The operator can adjust the processing parameters of the laser processing steps LPS, and is not limited thereto.

As described above, the tooth surface laser processing method and the laser processing system thereof of the invention can perform laser processing steps to form laser processed structures. A laser processed structure includes micro grooves and the micro bumps to increase reflection and scattering of incident light, so that whitening effect is improved. In addition, the micro grooves and the micro bumps can increase the hydrophobicity of the surface of the tooth to improve the anti-stain and the antibacterial effects. Furthermore, micro-nano grooves and micro-nano bumps can be formed on the surface of the micro grooves and the micro bumps to further improve the whitening effect and the antibacterial effect.

The invention has been described by the related embodiments above. However, the embodiments above are only examples for implementing the invention. It should be noted that the disclosed embodiments do not limit the scope of the invention. On the contrary, modifications and equivalent arrangements within the spirit and scope of the claims are included in the scope of the invention.

What is claimed is:

1. A laser processing method for a tooth, comprising:
performing a preliminary inspection on the tooth to obtain dental information and determine whether the tooth is suitable for laser processing steps;
selecting a laser processing system according to the dental information, and selecting and loading a laser parameter according to position and degree of processing required on a surface of the tooth; and
by using the laser processing system, performing the laser processing steps on the surface of the tooth to form a laser processed structure on the surface of the tooth, wherein the laser processed structure includes a plurality of micro grooves and a plurality of micro bumps between the micro grooves.

2. The laser processing method according to claim 1, wherein the tooth includes an artificial denture.

3. The laser processing method according to claim 1, wherein the surface of the tooth includes a tooth crown surface.

4. The laser processing method according to claim 1, wherein the laser processed structure is formed on an outer side surface, a top side surface and an inner side surface of the surface of the tooth.

5. The laser processing method according to claim 1, wherein the micro grooves are formed by using a laser beam of the laser processing system, the micro grooves comprise a plurality of first micro grooves and a plurality of second micro grooves formed on the surface of the tooth, and the first micro grooves interlace with the second micro grooves.

6. The laser processing method according to claim 1, wherein the micro grooves have a pitch between 0.5 μm and 500 μm.

7. The laser processing method according to claim 1, wherein the micro grooves have a groove width between 0.5 μm and 500 μm.

8. The laser processing method according to claim 1, wherein the micro grooves have a groove depth between 0.5 μm and 500 μm.

9. The laser processing method according to claim 1, wherein the micro grooves have a side wall inclined angle between 1° and 80°.

10. The laser processing method according to claim 1, further comprising forming a micro-nano processed structure on the micro grooves and the micro bumps, wherein the micro-nano processed structure includes a plurality of micro-nano grooves and a plurality of micro-nano bumps between the micro-nano grooves.

11. The laser processing method according to claim 10, wherein a groove width of the micro-nano groove is smaller than a groove width of the micro groove.

12. The laser processing method according to claim 10, wherein the laser processing steps include a combined step for simultaneously forming the laser processed structure and the micro-nano processed structure.

13. A laser processing system, comprising:
a laser source irradiating a laser beam;
a scanning unit receiving the laser beam and irradiating the laser beam on a surface of a tooth to form a laser processed structure on the surface of the tooth, wherein the laser processed structure includes a plurality of micro grooves and a plurality of micro bumps between the micro grooves; and
a control unit electrically connecting to the laser source and the scanning unit to control the laser source and the scanning unit.

14. The laser processing system according to claim 13, further comprising a transmitting unit connected to the laser source and the scanning unit and configured to transmit the laser beam.

15. The laser processing system according to claim 14, wherein the transmitting unit comprises a lens and a reflector for transmitting the laser beam.

16. The laser processing system according to claim 13, wherein the scanning unit comprises a first galvanometer, a second galvanometer and a f-θ lens, the first galvanometer and the second galvanometer control an irradiation position of the laser beam onto the surface of the tooth, and the f-θ lens focuses the laser beam on the surface of the tooth.

17. The laser processing system according to claim 13, further comprising a U-shaped rail, wherein the scanning unit is disposed on the U-shaped rail to assist the scanner unit to align with the tooth.

18. The laser processing system according to claim 13, further comprising a light guiding unit for reflecting the laser beam to a top side surface or an inner side surface of the tooth.

19. The laser processing system according to claim 18, wherein the light guiding unit comprises a light guiding portion, a reflecting portion and a supporting portion, the reflecting portion is connected to the light guiding portion, and the supporting portion is connected to the reflecting portion.
